(19) United States
(12) Patent Application Publication
(10) Pub. No.: US 2026/0285731 A1
(43) Pub. Date: Sep. 24, 2026

(54) WATER FILTRATION SYSTEM AND METHOD OF USE

(71) Applicant: OUTREACH, INC., Union, IA (US)

(72) Inventors: FLOYD V. HAMMER, Union, IA (US); ISAAC M. MCNARY, El Dorado, KS (US)

(21) Appl. No.: 19/569,497

(22) Filed: Mar. 17, 2026

Related U.S. Application Data
(60) Provisional application No. 63/773,638, filed on Mar. 18, 2025.

(51) Int. Cl. C02F 9/20

(52) U.S. Cl. CPC C02F 9/20; C02F 2201/004; C02F 2201/005; C02F 2201/007; C02F 2201/009; C02F 2201/3222

(57) ABSTRACT

Disclosed herein are water filtration systems that utilize ultra-filtration and at least two multi-port valves to operate the system and periodically flush the filters. Specifically, the systems comprise a three-way supply valve configured to be in fluid connection with the input of at least two filters (a first filter and a second filter) and a three-way flush valve configured to be in fluid connection with the drain of the two filters. The outputs of the filters are in fluid connection with a two-way clean water valve which is in fluid connection with a vessel interior to the system or an output for potable water.

### CROSS-REFERENCE TO RELATED APPLICATIONS

This application claims priority under 35 U.S.C. § 119 to provisional application Ser. No. 63/773,638, filed Mar. 18, 2025, herein incorporated by reference in its entirety.

### TECHNICAL FIELD

The present disclosure relates generally to a water filtration system and method of use.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Potable water is essential for a healthy, productive life. In underdeveloped countries, or in places experiencing natural disasters, water-borne illnesses are a serious and significant threat. In some instances, persons must either travel long distances to obtain clean water, or risk contracting water-borne illnesses after consuming contaminated water. Water filtration and/or treatment systems can be life-changing for such persons and such communities. However, some water filtration systems are difficult for such communities to construct and maintain, and/or require a reliable power source.

Moreover, conventional water filtration systems utilize chlorine to disinfect the water. Unfortunately, chlorine treated water can have an off-putting smell. Additionally, chlorine treatments remove minerals like iron and manganese from the water, affecting the taste of the water.

Thus, there exists a need in the art for water purification systems capable of processing large volumes of water that are easy to install and operate and are also easily maintained. Additionally, there is a need in the art for water filtration systems that removes biological contaminants but retains the mineral content of the water.

### SUMMARY

Disclosed herein are water filtration systems comprising two water filters, each having an input, an output and a drain. The systems further comprise a supply valve having a first supply valve port in fluid connection with an unfiltered water supply, a second supply valve port in fluid connection with the input of the first water filter, and a third supply valve port in fluid connection with the input of the second water filter; a flush valve having a first flush valve port in fluid connection with a waste output, a second flush valve port in fluid connection with the drain of the first filter, and a third supply valve port in fluid connection with the drain of the second water filter; and a clean water valve in fluid connection with the output of the first water filter and in fluid connection with the output of the second water filter and in fluid connection with a clean water output, or a spigot in fluid connection with the output of the first water filter and/or the output of the second water filter.

In some embodiments, the system is sized for manual portability when empty of water. In some embodiments, the systems comprise a pre-filter prior to the supply valve. In some embodiments, the system comprises ultraviolet LED light exposure after the output of the first and second filters. In some embodiments, the system comprises a solar power energy source.

Disclosed herein are methods of filtering water comprising flowing unfiltered water through the water filtration system as disclosed herein, wherein the supply valve is positioned to allow unfiltered water to flow to the input of the first filter and the input of the second filter, and wherein the flush valve is positioned with the waste output closed; filtering the water by flowing the water through the inputs to the outputs of the first filter and the second filter; and delivering potable water through the clean water valve or spigot.

Disclosed herein are methods of backflushing the first filter comprising flowing unfiltered water through the water filtration system as disclosed herein, wherein the supply valve is positioned to allow unfiltered water to flow to the input of the second filter, and wherein the flush valve is positioned to close the drain of the second filter and open the drain of the first filter to the waste output; and backflushing the first filter with water from the output of the second filter. Disclosed herein are methods of backflushing the second filter comprising flowing unfiltered water through the water filtration system as disclosed herein, wherein the supply valve is positioned to allow unfiltered water to flow to the input of the first filter, and wherein the flush valve is positioned to close the drain of the first filter and open the drain of the second filter to the waste output; and backflushing the second filter with water from the output of the first filter. Disclosed herein are methods of flushing the first and second filters comprising flowing unfiltered water through the water filtration system as disclosed herein, wherein the supply valve is positioned to allow unfiltered water to flow to the input of the first filter and the input of the second filter, and wherein the flush valve is positioned with the waste output open; and flushing the first filter and the second filter with unfiltered water.

Disclosed herein are methods of filtering water comprising flowing unfiltered water through the water filtration system as described herein, wherein the supply valve is positioned to allow unfiltered water to flow to the input of the first filters and the input of the second filters, and wherein the flush valve is positioned with the waste output closed; filtering the water by flowing the water through the inputs to the outputs of the first filters and the second filters; and delivering potable water through the clean water valve, wherein the system is configured to deliver at least about 600 gallons of potable water per day with about 10 hours of sunlight.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows an exemplary water filtration system, with clean and dirty water tanks interior to the system.

FIG. 2 shows an exemplary water filtration system comprising a supply valve, a flush valve, an output for flushed water, and four clean water spigots.

FIG. 3 is a schematic of the interior of the system of FIG. 2.

FIG. 4, FIG. 5, FIG. 6, and FIG. 7 show embodiments of the filtration system comprising a three-way supply valve and a three-way flush valve in various operating modes.

FIG. 4 shows an exemplary water filtration system wherein the three-way supply valve and the three-way flush valve are in positions to allow dirty water to flow through the filters supplying potable water.

FIG. 5 shows an exemplary water filtration system wherein the three-way supply valve is set to allow dirty water to flow to the filters and the three-way flush valve is set to allow the dirty water to flush through the filters and out of the system.

FIG. 6 shows an exemplary water filtration system wherein the three-way supply valve and the three-way flush valve are set such that filtered water from the right two filters is used to flush the left two filters.

FIG. 7 shows an exemplary water filtration system wherein the three-way supply valve and the three-way flush valve are set such that filtered water from the left two filters is used to flush the right two filters.

FIG. 8 shows a conventional system comprising four two-way valves.

FIG. 9 shows an exemplary mobile water filtration system with interior clean and dirty water vessels and two multi-port valves on the top.

FIG. 10 shows an exemplary mobile water filtration system with two potable water spigots and a solar power source.

An artisan of ordinary skill in the art need not view, within isolated figure(s), the near infinite distinct combinations of features described in the following detailed description to facilitate an understanding of the present disclosure.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

### Water Filtration Systems

Disclosed herein are water filtration systems that utilize ultra-filtration and at least two multi-port valves to operate the system and periodically flush the filters.

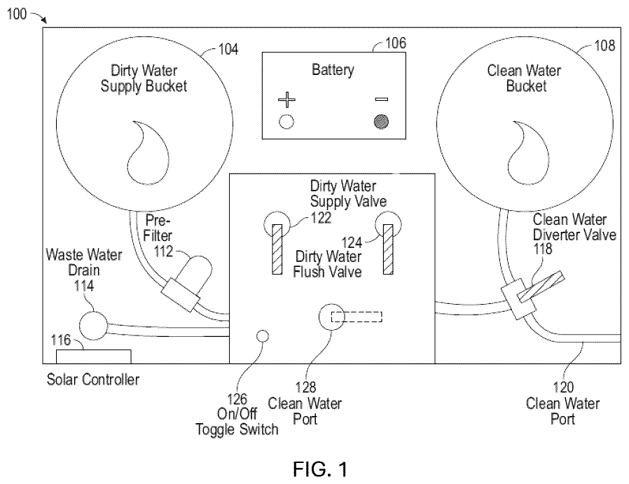

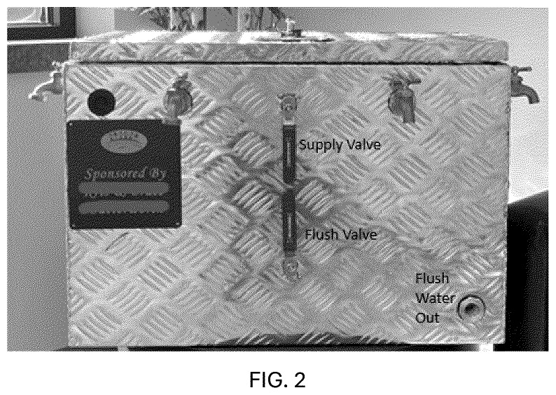

Exemplary water filtration systems are shown in FIG. 1 and FIG. 2.

The water filtration system 100 in FIG. 1 comprises a dirty water supply bucket 104 interior to the system in fluid connection with a pre-filter 112 and then a three-way supply valve 122. The three-way supply valve is configured to be in fluid connection with the input of at least two filters (a first filter and a second filter). The water filtration system as described herein further comprises a three-way flush valve 124 configured to be in fluid connection with the drain of the at least two filters (a first filter and a second filter). The outputs of the filters are in fluid connection with a clean water valve 118 which is in fluid connection with a vessel interior to the system. The exemplary water filtration system comprises a pump for pressurized water flow through the filtration system. When the system is configured to supply potable water, the supply valve 122 is set to allow dirty water to flow to at least two filters and the flush valve 124 is set to not allow water to flow to the drain, thereby forcing water through the filters to the output, and then to a clean water receptacle 108 via a clean water valve 118. When the system is configured to flush at least one filter with clean water, the supply valve 122 is set to allow dirty water to flow through a first filter, and the flush valve 124 is set to allow clean water from the output of the first filter to flow through the output of the second filter, thereby flushing the second filter with clean water and cleaning said filter. When configured to flush the other filter with clean water, the supply valve 122 is set to allow dirty water to flow through the second filter, and the flush valve 124 is set to allow clean water from the output of the second filter to flow through the output of the first filter, thereby flushing the first filter with clean water. Flushed water is thereafter sent to a waste water drain 114. The exemplary system shown in FIG. 1 further includes a battery 106 to power the system, wherein the battery is connected to a solar power energy source. The exemplary system in FIG. 1 further comprises a clean water port 120, 128 to remove potable water from the bucket interior to the system. The exemplary system further comprises a solar power source controller 116 and an on/off switch 126.

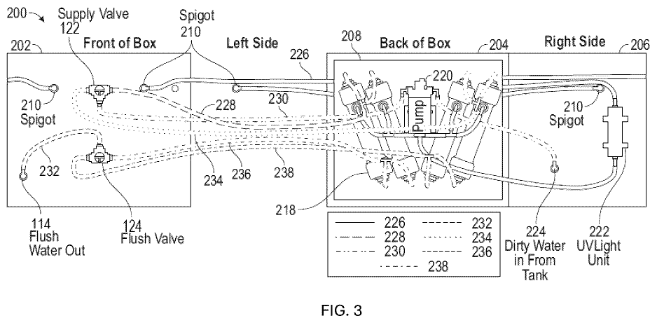

Another exemplary water filtration system is shown in FIG. 2. A schematic of the interior of this water filtration system is shown in FIG. 3. FIG. 3 shows the interior of the front of the box 202, the interior of the back of the box 204, the interior of the right side of the box 206, and the interior of the left side. As shown in FIG. 3, this embodiment does not comprise a dirty water supply bucket nor a clean water bucket interior to the system, but an input port 224 wherein unfiltered (or “dirty”) water enters the system. The input port 224 is in fluid connection 230 with a pump and thereafter the supply valve 122. This exemplary system 200 comprises a three-way supply valve 122 configured to be in fluid connection with the input of four filters 218 (two on the left 228, and two on the right 234). The supply valve 122 is accessible to the user at the front of the system as shown in FIG. 2. This embodiment comprises a three-way flush valve 124 configured to be in fluid connection 236, 238 with the drain of the four filters 218. The flush valve 124 is accessible to the user at the front of the system as shown in FIG. 2. The outputs of the four filters 218 are in fluid connection with a UV light unit 222, and thereafter in fluid connection 226 at least one of four spigots 210. This exemplary water filtration system comprises a pump 220 for pressurized water flow through the filtration system 208. When the system is configured to supply potable water, the supply valve 122 is set to allow dirty water to flow to all four filters 218 and the flush valve 124 is set to not allow water to flow to the drain, thereby forcing water through the filters 218 to the spigots 210 wherein the potable water can be assessed by a user. When the system 200 is configured to filter the two right filters with clean water, the supply valve 122 is set to allow dirty water to flow through the two left filters, and the flush valve 124 is set to allow clean water from the output of the two left filters to flow through the output of the two right filters, thereby backflushing the two right filters with clean water and cleaning said filters. When configured to flush the two left filters with clean water, the supply valve 124 is set to allow dirty water to flow through the right two filters, and the flush valve 124 is set to allow clean water from the output of the two right filters to flow through the output of the two left filters, thereby backflushing the two left filters with clean water. The flush valve 124 is in fluid connection 232 with a flush water out port 114 wherein the backflushed water leaves the system.

The water filtration system described herein is beneficially configured to backflush one filter with clean water from the output of another separate filter. This beneficially extends the life of the filters, maintaining the system. Additionally, the water filtration system described herein utilizes two multi-port valves for a user to conveniently and easily switch between flushing the filters and providing potable water. Conventional systems utilize four or more two-way valves. The use of a multi-port supply valve and a multi-port flush valve allows for easier setup and maintenance due to the use of fewer valves. Utilizing two multi-port valves over four or more two-way valves is also easier to use, and easier to teach others to use. A water filtration system that is easy to setup, maintain, use, and teach others to maintain and use is crucial for successful adoption of water filtration systems, especially in remote locations.

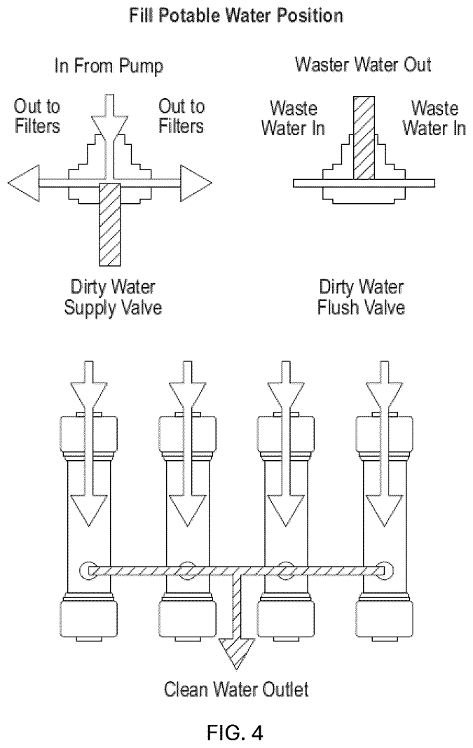

The filtration system as described herein is further described in the exemplary embodiments shown in FIGS. 4-7. FIGS. 4-7 illustrate the different configurations of the supply and flush valves for use of system, for example use of a system as shown in FIGS. 1-3 and 9-10. In FIGS. 4-7, the water filtration system comprises two three-way valves, one supply valve and one flush valve, and four filters. The supply valve has one port in fluid connection with dirty water and the other two ports are each in fluid connection to the input of two filters. The flush valve has one port in fluid connection to a system waste output and the other two ports are each in fluid connection with the drain of two filters. The outputs of each filter are in fluid connection with a clean water vessel, a clean water valve, or other clean water output. A user or a system configures the valves for use as described herein.

FIG. 4 shows the system configured to deliver potable water. The supply valve is in a position that allows dirty water to flow through the valve and to the input of each set of two filters. The flush valve is configured so that the system waste output, and thus the filter drains, are closed. In this configuration, dirty water is pumped through the filters and clean water flows from the filter output. With the flush valve in this position, pressure is maintained through the filters such that the water flows through the filters from input to output.

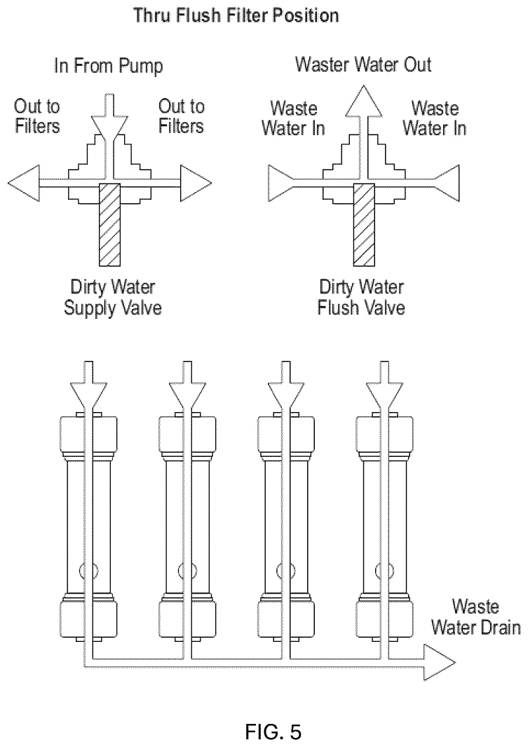

FIG. 5 shows the system configured to flush dirty water through the filters and out of the water filtration system, through the drain of the filters. This configuration allows for flushing the filters with unfiltered water. In this configuration, the supply valve is in a position that allows dirty water to flow through the valve and to the input of each set of two filters. The flush valve is in a position wherein the system waste output is open. Therefore, dirty water flows through the filters, out the filter drain and/or waste output, not the filter output.

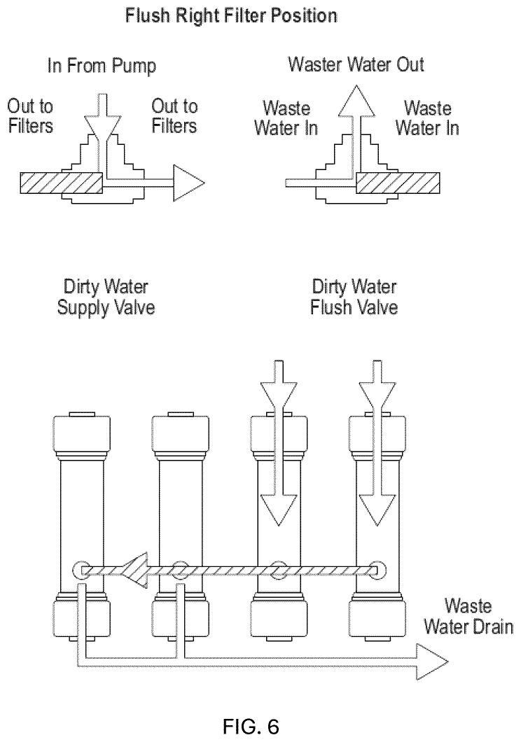

FIG. 6 shows the system configured to flush the two filters on the left with clean water from the two filters on the right. In this configuration, the supply valve is set to allow dirty water to flow into the two filters on the right, and not the two filters on the left. The flush valve is configured to allow water to flow out of the drain of the two filters on the left, while the drain on the right two filters is closed. This configuration maintains pressure on the filters such that the water flows from the outputs of the two filters on the right and through the outputs of the two filters on the left to the drain. This flushes (also called backflushing) the left two filters with filtered water. Periodic flushing cleans the filter so that the system can continue to provide potable water, and also helps extend the life of the filter.

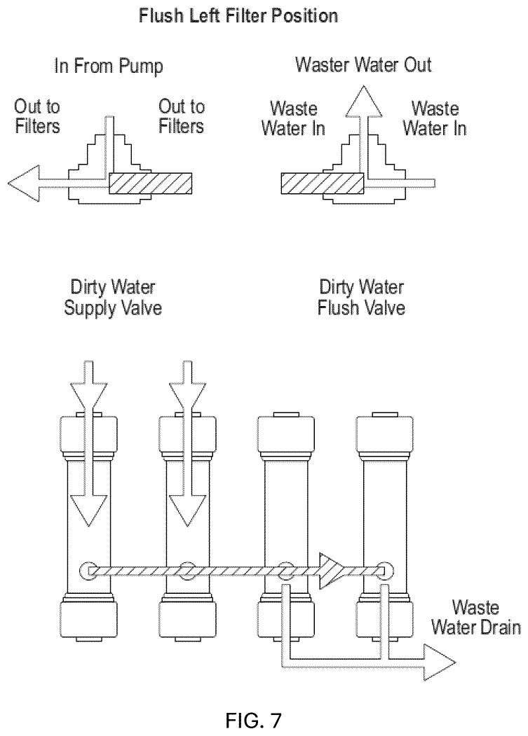

FIG. 7 shows the system configured to flush the two filters on the right with clean water from the two filters on the left. In this configuration, the supply valve is set to allow dirty water to flow into the two filters on the left, and not the two filters on the right. The flush valve is configured to allow water to flow out of the drain of the two filters on the right, while the drain on the left two filters is closed. This configuration maintains pressure on the filters such that the water flows from the outputs of the two filters on the left and through the outputs of the two filters on the right to the drain. This flushes (also called backflushing) the right two filters with filtered water. Periodic flushing cleans the filter so that the system can continue to provide potable water, and also helps extend the life of the filter.

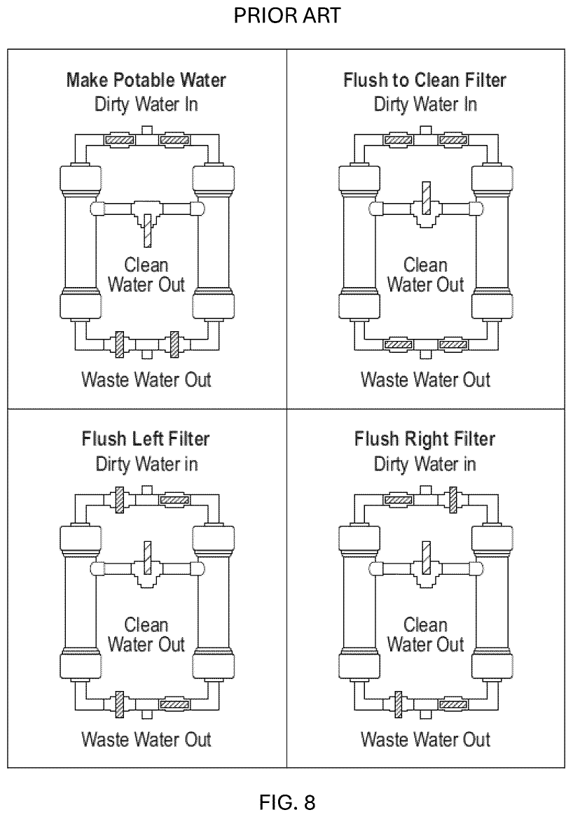

In contrast, conventional filtration systems that employ flushing one filter with the clean water from a separate filter comprise more than two, at least four, two-way valves. This conventional system is described in FIG. 8. As shown in FIG. 8, in the upper left, when configured to supply potable water, two supply valves must be opened while two flush valves must be closed. When configured to flush the filter with dirty water, all four valves must be opened. When configured to flush one filter with the clean water from a separate filter, the user must position all four valves to correctly to direct the water flow. Such systems can be confusing to set up, use and maintain, especially for the common user.

The systems as described herein utilize flow-through water filters. Such water filters have an input where unfiltered, or dirty, water enters, an output where filtered water exits, and a drain to release excess water and/or backwash and/or flushed water. Any water filter that removes contaminants as known in the art can be utilized in the system described herein. In an embodiment, the filters comprise a 0.01 micron pore size. In an embodiment, the filters comprise a pore size less than 0.02 micron. Exemplary water filters include, but are not limited to, ultra-filtration Everpure® filters from Pentair and AQUA CREST® filters from Aquacrest. In an embodiment, the water filtration system comprises at least two water filters. In an embodiment, the water filtration system comprises at least four water filters. In a preferred embodiment, the water filtration system comprises four water filters.

The systems as described herein utilize at least one multi-port supply valve and at least one multi-port flush valve. In a preferred embodiment, the supply valve and the flush valve are each three-way valves. The multi-port valves can be any multi-port valve as known in the art, suitable to direct water flow.

In an embodiment, the water filtration system comprises a pre-filter to remove larger debris from the unfiltered water prior to the supply valve. The pre-filter can be any pre-filter as known in the art. Exemplary pre-filters include, but are not limited to, pre-filters from Pentair, APEC, and Aquasana. In an embodiment, the pre-filter comprises activated carbon.

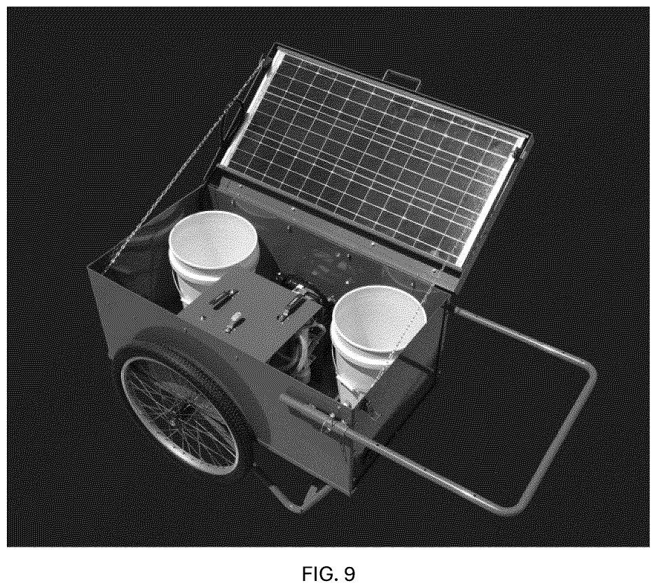

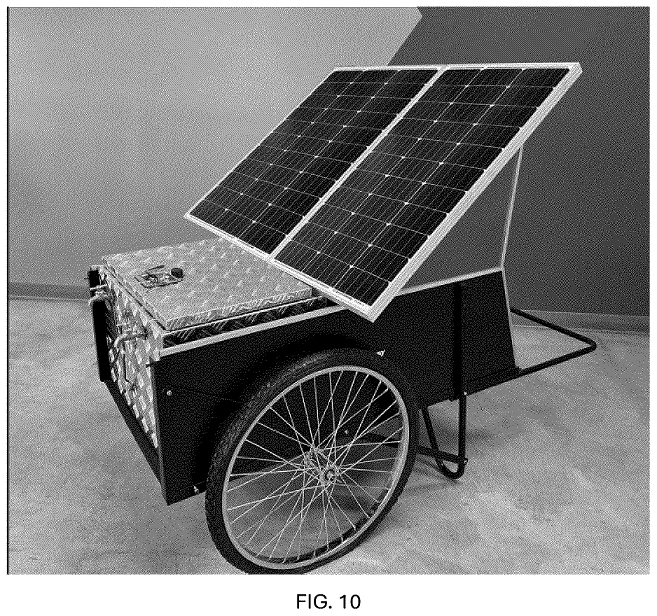

In an embodiment, the systems as described herein include a housing to enclose the filtration system, including the supply valve, the flush valve, and the filters. The housing can be of any material, and any shape and size as is appropriate for the filtration system. Preferably the housing is at least water resistant. Exemplary housings are shown in FIG. 2, FIG. 9 and FIG. 10. In FIG. 2 and FIG. 10, the housing is comprised of metal and is a size and shape to incorporate four filters, a supply valve, a flush valve, plastic tubing, a pump, and a UV light. In FIG. 9, the housing is comprised of metal and is a size and shape to incorporate at least two filters, a supply valve, a flush valve, tubing, a pump, a dirty water bucket, and a clean water bucket. In an embodiment, the systems as describe herein are a size and shape configured for air travel, either carry on or as checked luggage. In an embodiment, the system weighs less than 100 pounds, or less than 50 pounds, or less than 40 pounds. In an embodiment, the system has dimensions of 22 inches by 20 inches by 10 inches or less.

In an embodiment, the water filtration system comprises a container or vessel configured to store the unfiltered water and is in fluid connection with at least one supply valve. The container or vessel can be any such container configured to hold a liquid as is known in the art. It can be plastic or metal, and of any suitable size. In an embodiment, the unfiltered water container is within the filtration housing, as shown in FIG. 9. In another embodiment, the unfiltered water container is outside of the filtration housing. In another embodiment, the system does not comprise a container to hold unfiltered water.

In an embodiment, the water filtration system comprises a container or vessel configured to store clean water. The container or vessel can be any such container configured to hold a liquid as is known in the art. It can be plastic or metal, and of any suitable size. In an embodiment, the unfiltered water container is within the filtration housing, as shown in FIG. 9. In an embodiment, the clean water container is in fluid connection with the output of at least one filter. In an embodiment, the water filtration system further comprises a spigot or other means for emptying the clean water from the clean water container.

In an embodiment, the water filtration system comprises at least one spigot or other means to remove clean water from the system. The water filtration system may comprise a vessel to store the clean water or may not. In an embodiment, the spigot or other means of removing clean water from the system are in fluid connection with at least one output of at least one filter. Any spigot or means for removing clean water from the system as known in the art can be used herein. Exemplary spigots are shown in FIG. 2 and FIG. 10.

In an embodiment, the water filtration system comprises a pump or other means for pressurized flow of water through the system. The water pump can comprise any water pump as known in the art. Exemplary water pumps include, but are not limited to, Shurflo® by Pentair and Wassermann® by Wassermann. In an embodiment, the pump has a flow rate of 1.3 gallons per minute (GPM). In an embodiment, the pump has a flow rate of about 1.5 GPM.

In an embodiment, the system further comprises ultraviolet LED light exposure after filtration to remove or sterilize harmful viruses, bacteria, and parasites. Beneficially, the mineral content, and therefore the taste, of the water is not substantially disturbed. In an embodiment, the UV light waves utilized are 254 nm. Any UV LED systems as known in the art can be utilized herein. Exemplary UV LED include, but are not limited to, espwater® UV sleeves by ESP Water Products and Ultraviolet Disinfection Systems by Polaris and UV-C LED products from Canopus Water Technologies. In a preferred embodiment, the power to the UV LED light source is tied to the pump wherein the light source is only on when water is flowing through the system.

In an embodiment, the water filtration systems are configured to be mobile and comprise at least one wheel. Exemplary mobile water filtration systems are shown in FIG. 9 and FIG. 10. These exemplary systems comprise two wheels and a handle for mobility.

In an embodiment, the water filtration systems are configured to be stationary. An exemplary stationary water filtration system is shown in FIG. 2.

In an embodiment, the filtration system comprising four filters, a pump, a three-way supply valve, a three-way flush valve, a UV light exposure unit, and tubing, in a housing weighs about 49.5 pounds or less. Beneficially, these embodiments can be checked as luggage in most commercial airlines. An exemplary water filtration system that weighs about 49.5 pounds or less is shown in FIG. 2.

In a preferred embodiment, the water filtration systems as described herein do not comprise chlorination. Common types of chlorine used in conventional water treatment include chlorine gas, sodium hypochlorite and calcium hypochlorite. In a preferred embodiment, the systems described herein beneficially do not use chlorination or chlorine as a disinfectant. The use of chlorine can impart an unfamiliar scent and smell to the treated water, disincentivizing use of the treated water.

The water filtration systems as described herein can employ any power source as known in the art, for example a battery, or domestic or industrial electrical connections. In a preferred embodiment, the water filtration system comprises a solar power source. Beneficially, solar power enables the water filtration system to work in remote locations. Any solar power generation as known in the art can be used. An exemplary solar power source is shown in FIG. 9 wherein the solar power source is incorporated into the lid of the housing. In other embodiments, such as shown in FIG. 2 and FIG. 10, the solar power source is stationed adjacent to the water filtration system and plugged into a port of the housing. In a preferred embodiment, the solar power source comprises photovoltaic panels optimized for efficiency and durability in outdoor settings. In an embodiment, excess energy from the solar power panels is stored in a battery, for example a lithium-ion battery, to enable the system to function during low-sunlight conditions. Beneficially, lithium-ion batteries are lightweight and long-lasting. In an embodiment, the system comprises a smart charge controller configured to regulate energy distribution, manage charging cycles, and protect against power overload.

The water filtration systems as described herein may also include any control and/or measurement features, devices and sensors as known in the art. For example, the water filtration system may comprise an on/off switch, sensors to measure pressure, temperature, time, turbidity, cleanliness of the water at any point in the system, and the like, and combinations thereof. The water filtration systems as described herein may further comprise any control devices as known in the art, any communicating devices as known in the art, and any computing devices as known in the art. For example, the water filtration systems as described herein may comprise a device to record time of use, a device to measure and record output statistics such as gallons per day, or to measure and record days or gallons between filter flushing, and the like, and combinations thereof. The water filtration systems as described herein may further comprise devices known in the art to communicate any sort of recorded data to an offsite location. For example, a water filtration system as described herein may measure and record use statistics such as gallons of water filtered per day and send that data via wifi or Bluetooth or the like to a device or person offsite or onsite.

In an embodiment, the water filtration system as described herein comprises a system controller for data aggregation, usage statistics, and/or system control. In an embodiment, the controller comprises a microprocessor and analog pressure monitor. In this embodiment, an analog pressure monitor is placed between the pump and the filters to monitor filter performance, and to monitor usage. Changes in pressure are analyzed to determine if flushing, backflushing, or filter replacement is required. In an embodiment, the water filtration system comprises an indicator to alert a user that said flushing, backflushing, or filter replacement is required. Any indicator as known in the art can be used, for example a light, flashing light, and/or sound. In this embodiment, statistics can be gathered and monitored to indicate whether a system is in use, maintenance intervals, and the like. The controller can be peripheral to the water filtration system or embedded within. In an embodiment, the system comprises an antenna connection for an external antenna. In an embodiment, the controller comprises multiple networking capabilities for user interface, data collection, system updates, and the like. In an embodiment, 5G cellular is the primary networking method with wifi as backup. The user interface can be through a remote machine, or an application on a cellphone or other web-based device. In an embodiment, user access levels may limit availability of information or functions to specific groups. In an embodiment, the system controller allows a user to track statistics on any measurement.

In an embodiment, the water filtration system as described herein comprises an internal relay for leak mitigation. In this embodiment, the system beneficially can monitor for unattended usage or leaks and disable the pump.

In an embodiment, the water filtration system as described herein further comprises connection points for peripheral equipment. Exemplary peripheral equipment include those as known in the art for measuring and/or monitoring pressure, flow rate, pH, salinity, temperature, dosing, turbidity, conductivity and the like.

### Methods of Use

Disclosed herein are methods of filtering water utilizing any of the water filtration systems as described herein. Also disclosed herein are methods of flushing and backflushing the filters of the water filtration system.

In an embodiment, methods of delivering potable water comprise flowing unfiltered water through any of the water filtration systems as described herein, wherein the supply valve is positioned to allow unfiltered water to flow to the inputs of at least two filters, and wherein the flush valve is positioned with the waste output closed. This configuration allows the unfiltered water to flow through the input of the filters and to the output, delivering potable water at the output of the filters and through the clean water valve.

In an embodiment, a method of backflushing at least one first filter comprises flowing unfiltered water through any of the water filtration systems as described herein, wherein the supply valve is positioned to allow unfiltered water to flow to the input of a second filter, and wherein the flush valve is positioned to close the drain of the second filter and open the drain of the first filter to the waste output thereby forcing water from the output of the second filter through the output of the first filter, and backflushing the at least one first filter with water from the output of the second filter.

In an embodiment, a method of backflushing a second filter comprises flowing unfiltered water through any of the water filtration systems as described herein, wherein the supply valve is positioned to allow unfiltered water to flow to the input of the first filter, and wherein the flush valve is positioned to close the drain of the first filter and open the drain of the second filter to the waste output thereby forcing water from the output of the first filter through the output of the second filter, and backflushing the at least one second filter with water from the output of the first filter.

In an embodiment, a method of flushing a first and second filter comprises flowing unfiltered water through any of the water filtration systems as described herein, wherein the supply valve is positioned to allow unfiltered water to flow to the inputs of the filters, and wherein the flush valve is positioned with the waste output open, thereby and flushing the filters with unfiltered water.

In an embodiment, the system comprises at least two filters and a solar power supply source and the method delivers about 600 gallons of potable water a day with 10 hours of sunlight. In an embodiment, the system comprises at least four filters and a solar power supply and the method delivers up to about 1200 gallons of potable water a day with 10 hours of sunlight.

In an embodiment, each filter of the system is backflushed with filtered water at least once per day. Beneficially, flushing the filters at least once per day with filtered water can extend the lifetime of said filters to about 2 years, or up to about 800,000 gallons.

In an embodiment, the water filtration systems and methods as described herein further comprise adding a beneficial supplement to the filtered water. In an embodiment, a supplement may be for health and/or agricultural benefits. Supplements for health benefits include chloride, fluoride, medications, and/or antibiotics. Supplements for agricultural benefit include herbicides, pesticides, minerals, dyes, fertilizers, or other commercial purpose. Supplements can be added at any point in the system by any means as known in the art.

### EXAMPLES

A system comprising a three-way supply valve, a three-way flush valve, four filters, and an ultraviolet LED was utilized to supply potable water to a community in Tanzania. An embodiment of this system can be found in FIG. 2 and FIG. 3. The system used solar power. Over the course of four weeks, 600 gallons per day of potable water was supplied with approximately 10 hours of sunlight to power the system. The filters were flushed with clean water once per day, extending the lifetime of the cartridges.

The present disclosure is further defined by the following numbered embodiments:

1. A water filtration system comprising:
a first water filter having an input, an output, and a drain;
a second water filter having an input, an output, and a drain;
a supply valve having a first supply valve port in fluid connection with an unfiltered water supply, a second supply valve port in fluid connection with the input of the first water filter, and a third supply valve port in fluid connection with the input of the second water filter;
a flush valve having a first flush valve port in fluid connection with a waste output, a second flush valve port in fluid connection with the drain of the first filter, and a third supply valve port in fluid connection with the drain of the second water filter;
a clean water valve in fluid connection with the output of the first water filter and in fluid connection with the output of the second water filter and in fluid connection with a clean water output, or a spigot in fluid connection with the output of the first water filter and/or the output of the second water filter.

2. The water filtration system of embodiment 1, wherein the system is sized for manual portability when empty of water.

3. The water filtration system of any one of embodiments 1-2, further comprising a pump in fluid connection with the unfiltered water supply.

4. The water filtration system of any one of embodiments 1-3, further comprising a pre-filter prior to the supply valve.

5. The water filtration system of any one of embodiments 1-4, further comprising a housing configured to enclose at least a portion of the water filtration system.

6. The water filtration system of any one of embodiments 1-5, further comprising an unfiltered water vessel in fluid connection with the supply valve.

7. The water filtration system of any one of embodiments 1-6, further comprising a clean water vessel in fluid connection with the clean water output.

8. The water filtration system of any of embodiments 1-7, further comprising an ultraviolet LED light exposure after the output of the first and second filters.

9. The water filtration system of any one of embodiments 1-8, wherein the system does not comprise chlorine

10. The water filtration system of any one of embodiments 1-9, wherein the water filtration is mobile.

11. The water filtration system of any one of embodiments 1-9, wherein the water filtration is stationary.

12. The water filtration system of any one of embodiments 1-11, further comprising a battery.

13. The water filtration system of any one of embodiments 1-12, further comprising a solar power source.

14. The water filtration system of any one of embodiments 1-13, further comprising a system controller.

15. A water filtration system comprising:
at least two first water filters, each having an input, an output, and a drain;
at least two second water filters, each having an input an output, and a drain;
a supply valve having a first supply valve port in fluid connection with an unfiltered water supply, a second supply valve port in fluid connection with the inputs of the at least two first filters, and a third supply valve port in fluid connection with the inputs of the at least two second water filters;
a flush valve having a first flush valve port in fluid connection with a waste output, a second flush valve port in fluid connection with the drains of the at least two first filters, and a third supply valve port in fluid connection with the drains of the at least two second water filters;
a clean water valve in fluid connection with the outputs of the first water filters and in fluid connection with the outputs of the second water filters and in fluid connection with a clean water output, or at least one spigot in fluid connection with the output of the first water filter and/or the output of the second water filter;
a solar power source; and
ultraviolet LED exposure after the outputs of the first and second filters.

16. A method of filtering water comprising:
flowing unfiltered water through the water filtration system of any one of embodiments 1-15, wherein the supply valve is positioned to allow unfiltered water to flow to the input of the first filter and the input of the second filter, and wherein the flush valve is positioned with the waste output closed;
filtering the water by flowing the water through the inputs to the outputs of the first filter and the second filter; and
delivering potable water through the clean water valve or spigot.

17. A method of backflushing a first filter comprising:
flowing unfiltered water through the water filtration system of any one of embodiments 1-15, wherein the supply valve is positioned to allow unfiltered water to flow to the input of the second filter, and wherein the flush valve is positioned to close the drain of the second filter and open the drain of the first filter to the waste output; and
backflushing the first filter with water from the output of the second filter.

18. A method of backflushing a second filter comprising:
flowing unfiltered water through the water filtration system of any one of embodiments 1-15, wherein the supply valve is positioned to allow unfiltered water to flow to the input of the first filter, and wherein the flush valve is positioned to close the drain of the first filter and open the drain of the second filter to the waste output; and
backflushing the second filter with water from the output of the first filter.

19. A method of flushing a first and second filter comprising:
flowing unfiltered water through the water filtration system of any one of embodiments 1-15, wherein the supply valve is positioned to allow unfiltered water to flow to the input of the first filter and the input of the second filter, and wherein the flush valve is positioned with the waste output open; and
flushing the first filter and the second filter with unfiltered water.

20. The method of embodiment 16, wherein the method delivers at least about 600 gallons of water in a day when in use for about 10 hours.

21. A method of filtering water comprising:
flowing unfiltered water through the water filtration system of embodiment 15, wherein the supply valve is positioned to allow unfiltered water to flow to the input of the first filters and the input of the second filters, and wherein the flush valve is positioned with the waste output closed;
filtering the water by flowing the water through the inputs to the outputs of the first filters and the second filters; and
delivering potable water through the clean water valve, wherein the system delivers at least about 600 gallons of potable water per day with about 10 hours of sunlight.

What is claimed is:

1. A water filtration system comprising:
a first water filter having an input, an output, and a drain;
a second water filter having an input, an output, and a drain;
a supply valve having a first supply valve port in fluid connection with an unfiltered water supply, a second supply valve port in fluid connection with the input of the first water filter, and a third supply valve port in fluid connection with the input of the second water filter;
a flush valve having a first flush valve port in fluid connection with a waste output, a second flush valve port in fluid connection with the drain of the first filter, and a third supply valve port in fluid connection with the drain of the second water filter;
a clean water valve in fluid connection with the output of the first water filter and in fluid connection with the output of the second water filter and in fluid connection with a clean water output, or a spigot in fluid connection with the output of the first water filter and/or the output of the second water filter.

2. The water filtration system of claim 1, wherein the system is sized for manual portability when empty of water.

3. The water filtration system of claim 1, further comprising a pump in fluid connection with the unfiltered water supply.

4. The water filtration system of claim 1, further comprising a pre-filter prior to the supply valve.

5. The water filtration system of claim 1, further comprising a housing configured to enclose at least a portion of the water filtration system.

6. The water filtration system of claim 1, further comprising an unfiltered water vessel in fluid connection with the supply valve.

7. The water filtration system of claim 1, further comprising a clean water vessel in fluid connection with the clean water output.

8. The water filtration system of claim 1, further comprising an ultraviolet LED light exposure after the output of the first and second filters.

9. The water filtration system of claim 1, wherein the system does not comprise chlorine.

10. The water filtration system of claim 1, wherein the water filtration system is mobile.

11. The water filtration system of claim 1, wherein the water filtration system is stationary.

12. The water filtration system of claim 1, further comprising a battery.

13. The water filtration system of claim 1, further comprising a solar power source.

14. The water filtration system of claim 1, further comprising a system controller.

15. A water filtration system comprising:
at least two first water filters, each having an input, an output, and a drain;
at least two second water filters, each having an input an output, and a drain;
a supply valve having a first supply valve port in fluid connection with an unfiltered water supply, a second supply valve port in fluid connection with the inputs of the at least two first filters, and a third supply valve port in fluid connection with the inputs of the at least two second water filters;
a flush valve having a first flush valve port in fluid connection with a waste output, a second flush valve port in fluid connection with the drains of the at least two first filters, and a third supply valve port in fluid connection with the drains of the at least two second water filters;
a clean water valve in fluid connection with the outputs of the first water filters and in fluid connection with the outputs of the second water filters and in fluid connection with a clean water output, or at least one spigot in fluid connection with the output of the first water filter and/or the output of the second water filter;
a solar power source; and
ultraviolet LED exposure after the outputs of the first and second filters.

16. A method of filtering water comprising:
flowing unfiltered water through the water filtration system of claim 1, wherein the supply valve is positioned to allow unfiltered water to flow to the input of the first filter and the input of the second filter, and wherein the flush valve is positioned with the waste output closed;
filtering the water by flowing the water through the inputs to the outputs of the first filter and the second filter; and
delivering potable water through the clean water valve or spigot.

17. A method of backflushing a first filter comprising:
flowing unfiltered water through the water filtration system of claim 1, wherein the supply valve is positioned to allow unfiltered water to flow to the input of the second filter, and wherein the flush valve is positioned to close the drain of the second filter and open the drain of the first filter to the waste output; and
backflushing the first filter with water from the output of the second filter.

18. A method of backflushing a second filter comprising:
flowing unfiltered water through the water filtration system of claim 1, wherein the supply valve is positioned to allow unfiltered water to flow to the input of the first filter, and wherein the flush valve is positioned to close the drain of the first filter and open the drain of the second filter to the waste output; and
backflushing the second filter with water from the output of the first filter.

19. A method of flushing a first and second filter comprising:
flowing unfiltered water through the water filtration system of claim 1, wherein the supply valve is positioned to allow unfiltered water to flow to the input of the first filter and the input of the second filter, and wherein the flush valve is positioned with the waste output open; and
flushing the first filter and the second filter with unfiltered water.

20. A method of filtering water comprising:
flowing unfiltered water through the water filtration system of claim 15, wherein the supply valve is positioned to allow unfiltered water to flow to the input of the first filters and the input of the second filters, and wherein the flush valve is positioned with the waste output closed;
filtering the water by flowing the water through the inputs to the outputs of the first filters and the second filters; and
delivering potable water through the clean water valve, wherein the system is configured to deliver at least about 600 gallons of potable water per day with about 10 hours of sunlight.
